(19) United States
(12) Patent Application Publication
(10) Pub. No.: US 2012/0233042 A1
(43) Pub. Date: Sep. 13, 2012

(54) SYSTEM AND METHOD FOR REGISTRATION, AND SYSTEM AND METHOD FOR MANAGING ELECTRONIC REVENUE AND EXPENDITURE VOUCHERS USING THE SAME

(76) Inventor: Gi Gi Chen, Taipei (TW)

(21) Appl. No.: 13/414,399

(22) Filed: Mar. 7, 2012

(30) Foreign Application Priority Data
Mar. 8, 2011 (TW) 100107820
May 20, 2011 (TW) 100117771

(51) Int. Cl. G06Q 40/00; G06F 21/00

(52) U.S. Cl. 705/30; 726/5

(57) ABSTRACT

The present invention provides a system and a method for registration, and a system and a method for managing electronic revenue and expenditure that are user-friendly and environment-friendly. The registration system comprises a host unit and a plurality of user units. The host unit comprises a database, a member platform and an identification code input device. Each of the user units comprises the identification code and a user device having a display. When the identification code input device accesses the identification code for the first time, the member platform creates an account corresponding to the identification code and sends a password through the first communication path to the user device corresponding to the identification code so that the member is able to log on to the member platform.

### FIELD OF THE INVENTION

The present invention relates to a system and a method for registration, and a system and a method for managing electronic revenue and expenditure vouchers using the same and, more particularly, to a system and a method for registration that are user-friendly and environment-friendly, and a system and a method for managing electronic revenue and expenditure vouchers using the method and the system.

### BACKGROUND OF THE INVENTION

With the increasing emphasis on environmental issues, energy saving as well as carbon emission reduction has become crucial to the life of human beings. For example, to reduce the use of paper, paperless electronic vouchers (such as unified invoices, receipts, invoices, bills, debit notes, Beleg, Rechnung, etc.) have been advocated by most of the nations. However, the implementation of such paperless electronic vouchers also result in some troubles the service providers cannot overcome, which hinders the adoption of electronic vouchers.

Conventionally, an electronic revenue and expenditure voucher is issued as described in the flowchart shown in FIG. 1. When a customer goes shopping and wants to pay (Step 101), the clerk asks him/her whether he/she needs an electronic revenue and expenditure voucher (Step 103). If the answer is no, a paper voucher is printed by a conventional POS system (Step 105). If an electronic voucher is preferred, the customer will be inquired whether he/she is a member (Step 121).

If the customer is a member, he/she has to show the membership card so that information of the member can be accessed (Step 141) to create and save a file of an electronic revenue and expenditure voucher (Step 143). Finally, the file is attached in an email and is thereby sent to an email box of the member (Step 145).

If, however, the customer is not a member, he/she has to apply for a membership card (Step 123) and create a membership account (Step 125) to become a member. And then, Steps 141, 143 and 145 will be traversed.

Since the membership card is not accepted for other shops, if the customer desires to have all vouchers electronic, he/she has to apply for a membership card for each shop and bring tens of membership cards with him/her. In addition, there are also other cards such as credit cards, pre-paid cards, the Taiwan Easy Card, etc. Even though these plastic cards help to achieve paperless environment, they are by no means environment-friendly because that plastic cards are not biodegradable.

Moreover, one has to fill out basic information that is to be verified before a membership card is issued and a membership account is created. Consequently, not only the customer has to spend precious time filling out basic information on the spot, but also those who come after the applicant have no choice but to wait in line to pay their bills while the clerk is creating the membership account.

Alternatively, some service providers issue anonymous cards. The customer may ask for a revenue and expenditure voucher card when he/she desires. Therefore, the customer may inquire or receive an electronic revenue and expenditure voucher according to the revenue and expenditure voucher card. In this method, business transaction is accelerated by saving time for applying for membership and receiving the membership card. However, the problems resulting from the fact that each card corresponds to one shop still remain unsolved. Moreover, the shops usually identify membership validity by cards instead of users. Once the card gets lost or damaged, the revenue and expenditure voucher corresponding thereto will be considered lost and cannot be a basis for lottery check or other uses.

Furthermore, after an electronic revenue and expenditure voucher is issued, it is usually stored in the system of the shop. Some shops provide lottery check on behalf of the customer, while most shops only keep the voucher so that the customer has to log on to the website of the shop for lottery check. Consequently, the customer has to log on to respective websites of the shops to retrieve the revenue and expenditure voucher from the database for lottery check within a designated period of time, which results in a waste of time and easily causes an oversight.

In some countries, where the unified invoice system is not adopted, the receipt is similar to the revenue and expenditure voucher and the problems still remain.

### SUMMARY OF THE INVENTION

It is one objective of the present invention to provide a system and a method for registration that are user-friendly and environment-friendly, and a system and a method for managing electronic revenue and expenditure vouchers using the method and the system.

It is another objective of the present invention to provide a registration system, wherein an account is created after an identification code is inputted into a host unit, and then a password is sent to a user unit so that the member is able to log on to a member platform and fill out basic information.

It is still another objective of the present invention to provide a registration system, wherein the host unit comprises a database, a member platform and an identification code input device for storing member information, providing account management and accessing an identification code of a member, respectively.

It is still another objective of the present invention to provide a registration system, wherein each user unit comprises the identification code and a user device, each user device has a display.

It is still another objective of the present invention to provide a registration system, wherein the identification code input device is selectively one of an electronic data capture, a keyboard, a bar code reader, an RFID sensor or a combination thereof.

It is still another objective of the present invention to provide a registration system, wherein the identification code is selectively one of an identification number, a passport number, a telephone number, a mobile telephone number, an email address, a business registration number, a specified account or a combination thereof.

It is still another objective of the present invention to provide a registration system, wherein the user device is selectively one of a mobile phone, a computer, a personal digital assistant, a laptop computer, a multi-media player or a combination thereof.

It is still another objective of the present invention to provide a registration method, wherein an account is created after an identification code is inputted into a host unit, and then a password is sent to a user device so that the member is able to log on to the account.

It is still another objective of the present invention to provide a registration method, wherein the identification code is provided by a method selected from the group consisting of dictation, key-in, card access, RFID access and a combination thereof.

It is still another objective of the present invention to provide a registration method, wherein the member is able to log on to the member platform using the identification code and password for account management and filling out basic information after the user device receives the password.

It is still another objective of the present invention to provide an electronic revenue and expenditure voucher management system, wherein a central unit is connected with a plurality of shop units so that the member is able to manage electronic revenue and expenditure vouchers on the central unit.

It is still another objective of the present invention to provide an electronic revenue and expenditure voucher management system, wherein an account on each shop unit is created according to an identification code and the revenue and expenditure voucher information is imported into the central account according to the identification code when the central unit is connected or the revenue and expenditure voucher information is imported after the central account according to the identification code is created.

It is still another objective of the present invention to provide an electronic revenue and expenditure voucher management system, wherein the identification code is the only identification code for each identity so that it will not cause repetition and confusion among the shop units and the central unit.

It is still another objective of the present invention to provide an electronic revenue and expenditure voucher management system, wherein the identification code is selectively one of an identification number, a passport number, a telephone number, a mobile telephone number, an email address, a business registration number, a specified account or a combination thereof.

It is still another objective of the present invention to provide an electronic revenue and expenditure voucher management system, wherein the identification code is provided by a method selected from the group consisting of dictation, key-in, card access, RFID access and a combination thereof.

It is still another objective of the present invention to provide an electronic revenue and expenditure voucher management system, wherein the user device is selectively one of a mobile phone, a computer, a personal digital assistant, a laptop computer, a multi-media player or a combination thereof.

It is still another objective of the present invention to provide an electronic revenue and expenditure voucher management system, wherein the shop unit sends the revenue and expenditure voucher code or the consuming details to the user device via messages or emails after an electronic revenue and expenditure voucher is issued.

It is still another objective of the present invention to provide an electronic revenue and expenditure voucher management system, wherein revenue and expenditure voucher management comprises creation and management of a central account, expenditure statistics, expenditure inquiry, lottery check, revenue and expenditure voucher donation.

It is still another objective of the present invention to provide a method for managing an electronic revenue and expenditure voucher system, wherein an account in each shop unit and a central account in a central unit are created according to an identification code so that these accounts may be integrated for revenue and expenditure voucher management.

It is still another objective of the present invention to provide a method for managing an electronic revenue and expenditure voucher system, wherein a password is sent to a user device after the account is created so that the member is able to manage the account and electronic revenue and expenditure vouchers.

It is still another objective of the present invention to provide a method for managing an electronic revenue and expenditure voucher system, wherein a revenue and expenditure voucher code is created and sent to a user device after the electronic revenue and expenditure voucher is created so that the member is able to inquire the electronic revenue and expenditure voucher.

It is still another objective of the present invention to provide a method for managing an electronic revenue and expenditure voucher system, wherein the consuming details are created and sent to a user device after an electronic revenue and expenditure voucher is created so that the member is able to check the voucher and revoke the parking fee.

It is still another objective of the present invention to provide a method for managing an electronic revenue and expenditure voucher system, wherein expenditure statistics, expenditure inquiry, lottery check, and revenue and expenditure voucher donation are available.

The present invention provides a registration system, comprising: a host unit provided with a database, a member platform and an identification code input device for storing member information, providing account management and accessing an identification code of a member, respectively; and a plurality of user units, wherein each user unit comprises said identification code and a user device, each user device has a display and is able to connect with said host unit through a first communication path; wherein said member platform creates an account corresponding to said identification code and sends a password corresponding to said identification code through said first communication path to said user device corresponding to said identification code so that the member is able to log on to said member platform when said identification code input device accesses said identification code for the first time.

The present invention further provides a registration method, comprising steps of: providing a host unit comprising a database, a member platform and an identification code input device; accessing an identification code by said identification code input device; creating an account corresponding to said identification code when said member platform determines that said identification code is accessed for the first time; and sending a password to a user device corresponding to said identification code.

The present invention further provides an electronic revenue and expenditure voucher management system, comprising: a central unit provided with a central database and a management platform for storing revenue and expenditure voucher information and providing functions of revenue and expenditure voucher management, respectively; a plurality of shop units, wherein each shop unit is connected to said central unit through a first communication path and comprises a revenue and expenditure voucher generator, a shop platform and a shop database for generating an electronic revenue and expenditure voucher with an revenue and expenditure voucher code, performing account management and accounting calculation, and storing revenue and expenditure voucher information, respectively; and a plurality of user units, wherein each user unit comprises an identification code and a user device, each user device has a display and is able to connect with said central unit and said shop units through a second communication path so as to receive and display said revenue and expenditure voucher code; wherein each of said shop units is provided with an identification code input module and an electronic revenue and expenditure voucher generating module for accessing said identification code of a member, generating said electronic revenue and expenditure voucher with said revenue and expenditure voucher code, respectively; wherein said shop platform sends said revenue and expenditure voucher code through said second communication path to said user device corresponding to said identification code.

The present invention further provides a method for managing an electronic revenue and expenditure voucher system, comprising steps of: providing a central unit and a plurality of shop units, wherein said central unit comprises a central database and a management platform and each of said shop units comprises an revenue and expenditure voucher generator, a shop platform and a shop database; providing an identification code of a member in one of said shop units; creating an account corresponding to said identification code and sending a password to a user device of the member corresponding to said identification code when said shop platform determines that said identification code is accessed for the first time; generating an electronic revenue and expenditure voucher with an revenue and expenditure voucher code according to the expenditure of the member; storing said electronic revenue and expenditure voucher into said shop database corresponding to said account; sending said revenue and expenditure voucher code to said user device of the member; connecting said shop units with said central unit; creating a central account corresponding to said identification code and sending another password to said user device when said management platform determines that said identification code is accessed for the first time; and importing said electronic revenue and expenditure voucher into said central database corresponding to said central account.

### BRIEF DESCRIPTION OF THE DRAWINGS

The objects and spirits of the embodiments of the present invention will be readily understood by the accompanying drawings and detailed descriptions, wherein:

FIG. 1 is a flowchart of a conventional method for issuing an electronic revenue and expenditure voucher;

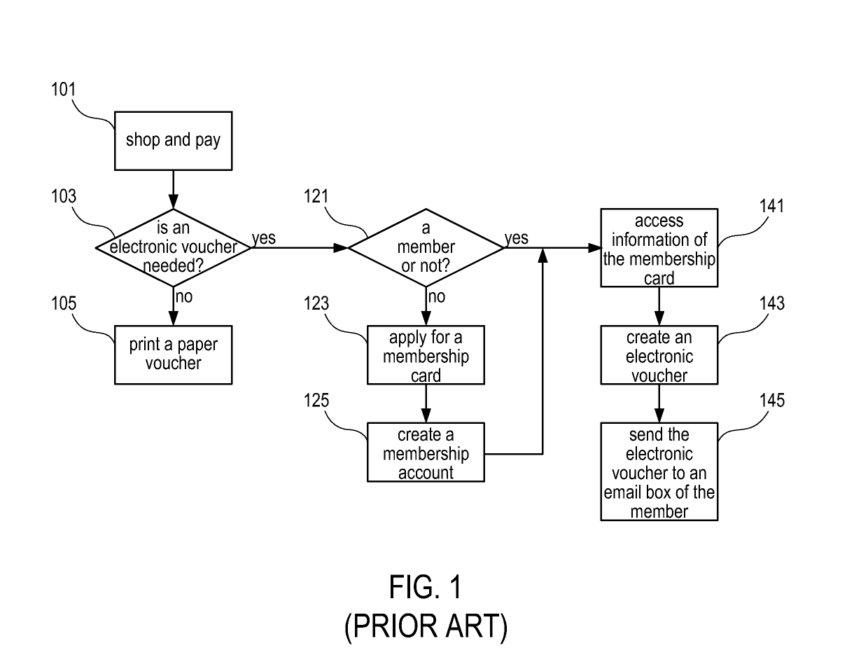

FIG. 2 is a schematic diagram of a registration system in accordance with one embodiment of the present invention;

FIG. 3 is a flowchart of a registration method in accordance with one embodiment of the present invention;

FIG. 4 is a schematic diagram of an electronic revenue and expenditure voucher management system in accordance with one embodiment of the present invention; and

FIG. 5 is a flowchart of a method for managing an electronic revenue and expenditure voucher system in accordance with one embodiment of the present invention.

### DETAILED DESCRIPTION OF THE PREFERRED EMBODIMENTS

The present invention may be exemplified but not limited by various embodiments as described hereinafter.

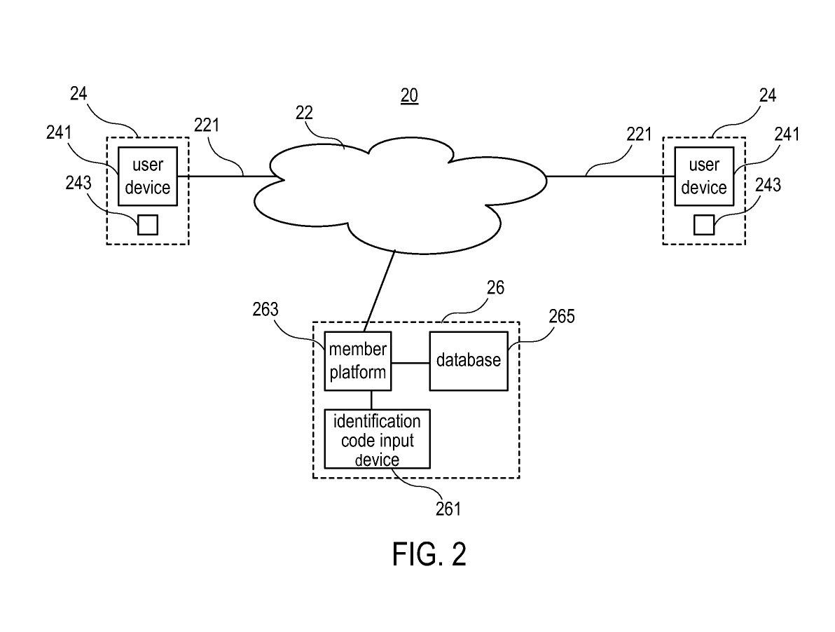

Please refer to FIG. 2 for a schematic diagram of a registration system in accordance with one embodiment of the present invention. In FIG. 2, the registration system 20 of the present invention comprises a host unit 26 and a plurality of user units 24.

The host unit 26 comprises a database 265, a member platform 263 and an identification code input device 261. The database 265 is used for storing member related information. A member may log on to the member platform 263 for account management. The identification code input device 261 is capable of accessing an identification code of the member.

Each of the user units 24 comprises a user device 241 and an identification code 243. Each user device 241 has a display, and is able to be connected with the host unit 26 through a first communication path 22.

When the identification code input device 261 accesses an identification code 243 for the first time, the member platform 263 creates an account corresponding to the identification code 243 and sends a password through the first communication path 22 to the user device 241 corresponding to the identification code 243.

The user device 241 has a display for displaying the password. The member can use the user device 241 to connect with the host unit 26 through the first communication path 22, and log on to the member platform 263 according to the identification code 243 and the password for account management or filling out basic information.

In one embodiment of the present invention, the identification code input device 261 is selectively one of an electronic data capture, a keyboard input, a bar code reader, an RFID sensor or a device provided with functions thereof. The identification code 243 is selectively one of an identification number, a passport number, a telephone number, a mobile telephone number, an email address, a business registration number, a specified account or a combination thereof, which is unique and representative.

In one embodiment of the present invention, the identification code 243 is provided by a method selected from the group consisting of dictation, key-in, card access, RFID access and a combination thereof. The user device 241 is selectively one of a mobile phone, a computer, a personal digital assistant, a laptop computer, a multi-media player and a combination thereof. The first communication path 22 is selectively one of a network, a wireless communication network or a wired communication network.

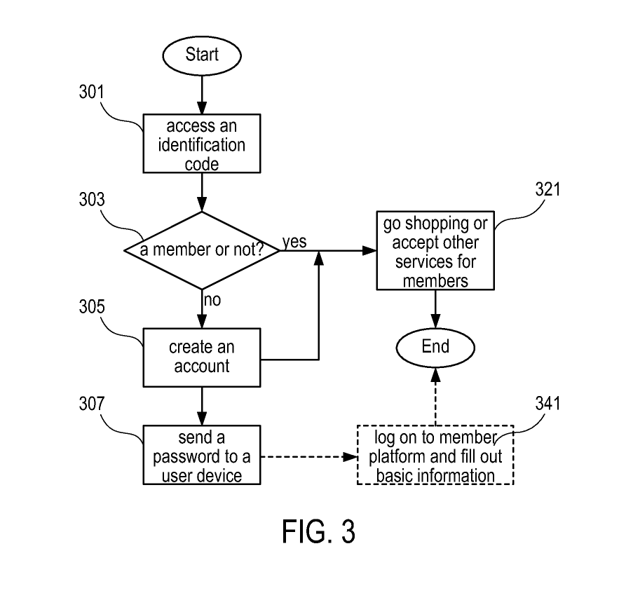

Please refer to FIG. 3 for a flowchart of a registration method in accordance with one embodiment of the present invention. The registration system of the present invention comprises a host unit, which is provided with a database, a member platform and an identification code input device. The registration method of the present invention starts with a step of accessing an identification code by the identification code input device as shown in Step 301. The member platform searches data from the database and determining whether the identification code corresponds to any account as in Step 303.

If the identification code corresponds to an account, the member is able to go shopping or accept other services for members. The business transaction or the service information will be stored in the database as in Step 321.

If, however, the identification code does not correspond to any account, an account will be created on the member platform corresponding to the identification code and a password corresponding to the identification code will be sent to the user device as in Step 305 and in Step 307. After the account corresponding to the identification code is created, the member is able to go shopping or accept services for members. The business transaction or the service information will be stored in the database as in Step 321.

The member is able to log on to the member platform according to the identification code and the password for account management or filling out basic information after the password is received, as in Step 341.

By the use of the registration method of the present invention, the new applicants and old members have no difficulties in shopping or accepting services and may store the business transaction or the service information, as member behavior information, in a corresponding account in the database. Afterwards, the new applicants may complete membership registration by logging on to the member platform according to the identification code and the password for account management or filling out basic information.

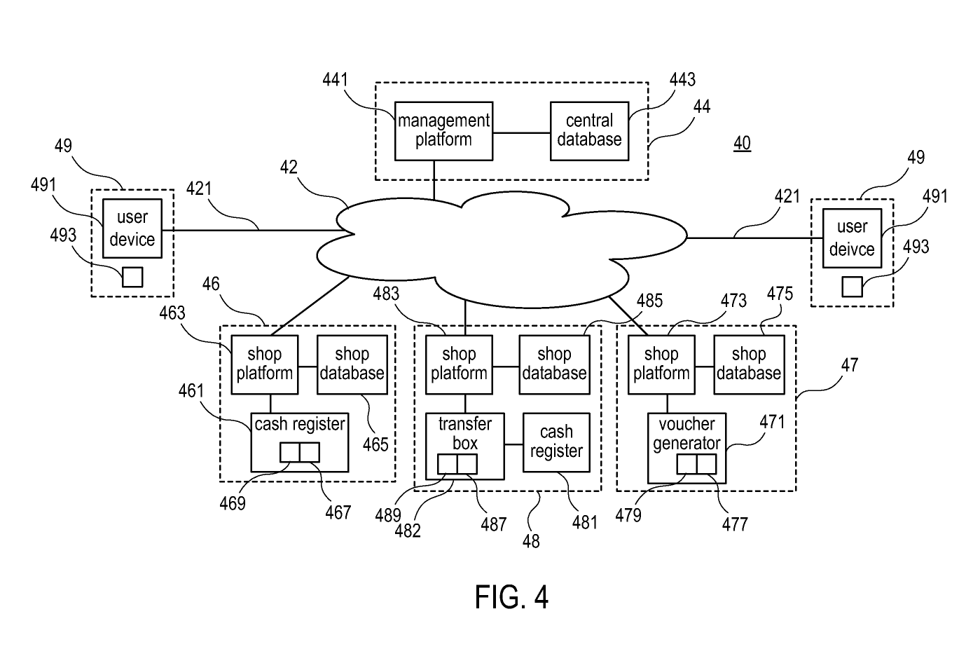

Please refer to FIG. 4 for a schematic diagram of an electronic revenue and expenditure voucher management system in accordance with one embodiment of the present invention. In FIG. 4, the electronic revenue and expenditure voucher management system 40 of the present invention comprises a central unit 44, a plurality of shop units 46, 48 and a plurality of user units 49.

The central unit 44 comprises a central database 443 and a management platform 441. The central database 443 stores revenue and expenditure voucher information, comprising items, revenues, shops and a corresponding central account and an identification code 493. The management platform 441 provides revenue and expenditure voucher management and central account management.

The shop units 46, 47, 48 are connected to the central unit 44 through a first communication path 42. Each of the shop units 46, 47, 48 comprises a voucher generator 461, 471, 481, a shop platform 463, 473, 483 and a shop database 465, 475, 485. The voucher generators 461, 471, 481 are used for printing paper revenue and expenditure vouchers or generating electronic revenue and expenditure vouchers. The consuming details on the paper revenue and expenditure vouchers and the electronic revenue and expenditure vouchers are combined by the shop platforms 463, 473, 483 and are then stored in the shop databases 465, 475, 485.

The above-mentioned voucher generators 461, 471, 481 may be a cash register (for example, 461, 471) or a software (for example, 481).

The currently used cash register may be adapted to be used in the electronic revenue and expenditure voucher management system 40 of the present invention by modifying software, firmware or hardware, and adding an identification code input module 467 and an electronic revenue and expenditure voucher generating module 469, for example, the cash register 461. Alternatively, the currently used cash register may also be adapted to be used in the electronic revenue and expenditure voucher management system 40 of the present invention by being connected to an external transfer box 482 comprising an identification code input module 487 and an electronic revenue and expenditure voucher generating module 489, for example, the cash register 481. The identification code input modules 467, 487 are used for accessing the identification code 493 of a member. The electronic revenue and expenditure voucher generating modules 469, 489 are used for generating the electronic revenue and expenditure vouchers with the revenue and expenditure voucher code corresponding thereto. For systems using a computer to print computer revenue and expenditure vouchers (for example, the shop unit 47), the computer software 481 for generating the revenue and expenditure vouchers is provided with an electronic revenue and expenditure voucher generating module 479, which receives the identification code 493 input from a keyboard (an example of the identification code input module 478).

Each of the user units 49 comprises an identification code 493 and a user device 491. Each user device 491 can be connected with the central unit 44 and the shop units 46, 47, 48 through a second communication path 421. Each user device 491 has a display. The revenue and expenditure voucher code generated by the electronic revenue and expenditure voucher generating module 469 can be sent through the second communication path 421 to the user device 491 and be displayed on the display.

By using the electronic revenue and expenditure voucher management system of the present invention, the shop platforms 463, 473, 483 create an account corresponding to an identification code 493 and sends a password corresponding to the identification code 493 through the second communication path 421 to the user device 491 corresponding to the identification code 243 when the identification code input modules 467, 477, 487 access a new identification code 493 for the first time. The electronic revenue and expenditure voucher generated at the moment will be stored in the shop databases 465, 475, 485 and be corresponding to the account. The electronic revenue and expenditure voucher generating modules 469, 479, 489 generate the electronic revenue and expenditure voucher with a revenue and expenditure voucher code corresponding thereto, and then the revenue and expenditure voucher code will be sent to the user device 491. Therefore, the member is able to get connected to the shop platforms 463, 473, 483 through the network and log on to the account using the password for account management and checking the electronic revenue and expenditure voucher corresponding to the revenue and expenditure voucher code.

The revenue and expenditure voucher information corresponding to the identification code 493 is imported into the central database 443 when the shop units 46, 47, 48 are connected to the central unit 44 through the first communication path 42. If there is no central account corresponding to the identification code 493 on the management platform 441, a central account corresponding to the identification code 493 will be created on the management platform 441 and then the corresponding revenue and expenditure voucher information is imported into the central database 443. After the management platform 441 creates the central account corresponding to the identification code 493, a password is sent through the second communication path 421 to the corresponding user device 491. Therefore, the member is able to get connected to the management platform 441 through the network and log on to the central account corresponding to the identification code 493 using the password for revenue and expenditure voucher management.

In one embodiment of the present invention, the consuming details corresponding to the electronic revenue and expenditure voucher are created and sent to a user device 491 through the second communication path 421 when the electronic revenue and expenditure voucher generating modules 469, 479, 489 generate the electronic revenue and expenditure voucher so that the member is able to check the voucher and revoke the parking fee.

In one embodiment of the present invention, the identification code 493 is selectively one of an identification number, a passport number, a telephone number, a mobile telephone number, an email address, a business registration number, a specified account or a combination thereof, which is unique and representative. The identification code 493 is provided by a method selected from the group consisting of dictation, key-in, card access, RFID access and a combination thereof. Accordingly, the member may only bring one card or even none at all, to receive electronic revenue and expenditure vouchers on any shop that is provided with an electronic revenue and expenditure voucher management system 40 of the present invention. Moreover, each electronic revenue and expenditure voucher can be inquired and managed on the management platform 441 by logging on to the central account corresponding to the identification code 493. As a result, the member does not have to worry about the problems such as large number of cards, dispersed electronic revenue and expenditure vouchers from different shops, and the loss of cards. Each of the identification code input modules 467, 477, 487 is selectively one of an electronic data capture, a keyboard, a bar code reader, an RFID sensor and a device provided with functions thereof, which is capable of accessing the identification code 493 of a member.

In one embodiment of the present invention, the user device 491 is selectively one of a mobile phone, a computer, a personal digital assistant, a laptop computer, a tablet personal computer, a multi-media player or a combination thereof, which is capable of receiving and displaying the revenue and expenditure voucher code and the consuming details as well as the passwords corresponding to the account in the shop platforms 463, 473, 483 and the central account on the management platform 441. The first communication path 42 may be a network, while the second communication path 421 may be selectively one of a network, a wireless communication network, a wired communication network or a combination thereof.

In one embodiment of the present invention, the management platform 441 provides functions of revenue and expenditure voucher management including: creating and managing of central accounts, expenditure statistics, expenditure inquiry, lottery check, revenue and expenditure voucher donation and the combination thereof.

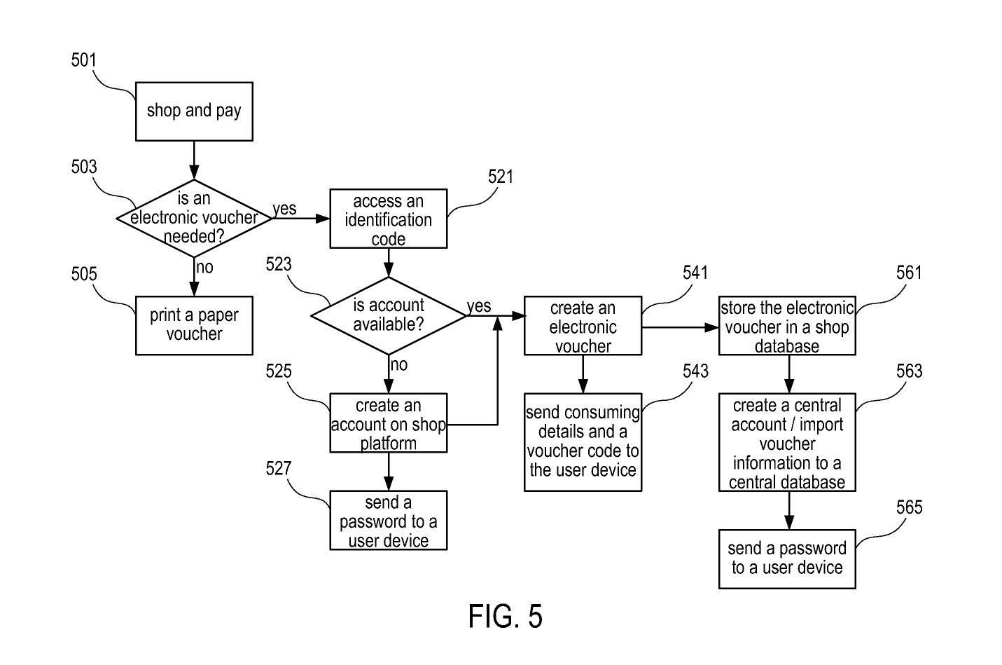

Please refer to FIG. 5 for a flowchart of a method for managing an electronic revenue and expenditure voucher system in accordance with one embodiment of the present invention. The electronic revenue and expenditure voucher management system comprises a central unit and a plurality of shop units. The central unit comprises a central database and a management platform. Each of the shop units comprises a revenue and expenditure voucher generator, a shop platform and a shop database.

The procedure of the method for managing the electronic revenue and expenditure voucher is as shown in the flowchart in FIG. 5. When a customer goes shopping and wants to pay as in Step 501, the clerk asks him/her whether he/she needs an electronic revenue and expenditure voucher as in Step 503. If the answer is no, a paper voucher is printed by a revenue and expenditure voucher generator as in Step 505.

If an electronic revenue and expenditure voucher is preferred, the customer will be asked to provide an identification code and access the identification code as in Step 521. Then, in Step 523, it is to be determined whether there is an account corresponding to the identification code in the shop platform. If the answer is yes, an electronic revenue and expenditure voucher is created with a revenue and expenditure voucher code corresponding thereto as in Step 541. In Step 541, the consuming details corresponding to the electronic revenue and expenditure voucher may also be generated. In Step 543, the revenue and expenditure voucher code and the consuming details may be sent to a user device of the member.

After the electronic revenue and expenditure voucher is generated, it is stored in the shop database according to the identification code and the account as in Step 561. When the shop unit is connected to the central unit, the revenue and expenditure voucher information is imported into the central database according to the identification code and the account as in Step 563.

If there is no account corresponding to the identification code in the shop platform, an account corresponding to the identification code will be created as in Step 525. Then, one can go through Step 541 to Step 563 for shopping and having electronic revenue and expenditure voucher. After the account is created in the shop platform, the password corresponding to the account is sent to the user device of the member so that the member is able to manage the account as in Step 527.

The shop unit must be connected to the central unit to import the revenue and expenditure voucher information at least once a day. If there is no central account corresponding to the identification code on the management platform, a central account corresponding to the identification code will be created, so that the revenue and expenditure voucher information can be imported into the central account corresponding to the identification code. Alternatively, the password corresponding to the central account will be sent to the user device after the central account is created on the management platform as in Step 565.

In one embodiment of the present invention, the member is able to check the voucher and revoke the parking fee according to the consuming details received by the user device. Also, the member is able to check and manage corresponding electronic revenue and expenditure vouchers on the shop platform or management platform by using the received revenue and expenditure voucher code.

After the account on the shop platform and the central account on the management platform have been created, the member is able to log on to these platforms according to the passwords to fill out basic information and adopt expenditure statistics, expenditure inquiry, lottery check, revenue and expenditure voucher donation or combination thereof.

In one embodiment of the present invention, the identification code is selectively one of an identification number, a passport number, a telephone number, a mobile telephone number, an email address, a business registration number, a specified account or a combination thereof, which is unique and representative. The user device is selectively one of a mobile phone, a computer, a personal digital assistant, a laptop computer, a tablet personal computer, a multi-media player or a combination thereof, which has a display and can be connected to a network or a communication network.

As mentioned above, by using the system and the method for registration, and the system and the method for managing electronic revenue and expenditure vouchers of the present invention, not only energy saving as well as carbon reduction can be achieved, but also that the customers and the shops can reduce the cost. Moreover, the customers may use only one card, even none at all, to enjoy shopping.

Furthermore, the management system and the management method can also be used in systems such as unified invoices, receipts, invoices, bills, debit notes, Beleg, and Rechnung, etc.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A registration system, comprising:
a host unit provided with a database, a member platform and an identification code input device for storing member information, providing account management and accessing an identification code of a member, respectively; and
a plurality of user units, wherein each user unit comprises said identification code and a user device, each user device has a display and is able to connect with said host unit through a first communication path;
wherein said member platform creates an account corresponding to said identification code and sends a password corresponding to said identification code through said first communication path to said user device corresponding to said identification code so that the member is able to log on to said member platform when said identification code input device accesses said identification code for the first time.

2. The registration system as recited in claim 1, wherein said identification code input device is selectively one of an electronic data capture, a keyboard input, a bar code reader, an RFID sensor or a device provided with functions thereof.

3. The registration system as recited in claim 1, wherein said identification code is selectively one of an identification number, a passport number, a telephone number, a mobile telephone number, an email address, a business registration number, a specified account or a combination thereof.

4. The registration system as recited in claim 1, wherein said identification code is provided by a method selected from the group consisting of dictation, key-in, card access, RFID access and a combination thereof.

5. The registration system as recited in claim 1, wherein said user device is selectively one of a mobile phone, a computer, a personal digital assistant, a laptop computer, a tablet personal computer, a multi-media player or a combination thereof.

6. The registration system as recited in claim 1, wherein said first communication path is selectively one of a network, a wireless communication network, a wired communication network or a combination thereof.

7. A registration method, comprising steps of:
providing a host unit comprising a database, a member platform and an identification code input device;
accessing an identification code by said identification code input device;
creating an account corresponding to said identification code when said member platform determines that said identification code is accessed for the first time; and
sending a password to a user device corresponding to said identification code.

8. The registration method as recited in claim 7, wherein said identification code is selectively one of an identification number, a passport number, a telephone number, a mobile telephone number, an email address, a business registration number, a specified account or a combination thereof.

9. The registration method as recited in claim 7, wherein said identification code is provided by a method selected from the group consisting of dictation, key-in, card access, RFID access and a combination thereof.

10. The registration method as recited in claim 8, further comprising a step of logging on to said member platform using said identification code and said password and filling out basic information.

11. An electronic revenue and expenditure voucher management system, comprising:
a central unit provided with a central database and a management platform for storing revenue and expenditure voucher information and providing functions of revenue and expenditure voucher management, respectively;
a plurality of shop units, wherein each shop unit is connected to said central unit through a first communication path and comprises a revenue and expenditure voucher generator, a shop platform and a shop database for generating an electronic revenue and expenditure voucher with an revenue and expenditure voucher code, performing account management and accounting calculation, and storing revenue and expenditure voucher information, respectively; and
a plurality of user units, wherein each user unit comprises an identification code and a user device, each user device has a display and is able to connect with said central unit and said shop units through a second communication path so as to receive and display said revenue and expenditure voucher code;
wherein each of said shop units is provided with an identification code input module and an electronic revenue and expenditure voucher generating module for accessing said identification code of a member, generating said electronic revenue and expenditure voucher with said revenue and expenditure voucher code, respectively; wherein said shop platform sends said revenue and expenditure voucher code through said second communication path to said user device corresponding to said identification code.

12. The electronic revenue and expenditure voucher management system as recited in claim 11, wherein said identification code input module and said electronic revenue and expenditure voucher generating module are disposed in said revenue and expenditure voucher generator or a transfer box connected to said revenue and expenditure voucher generator and said shop platform.

13. The electronic revenue and expenditure voucher management system as recited in claim 11, wherein said identification code input device is selectively one of an electronic data capture, a keyboard input, a bar code reader, an RFID sensor or a device provided with functions thereof.

14. The electronic revenue and expenditure voucher management system as recited in claim 11, wherein said identification code is selectively one of an identification number, a passport number, a telephone number, a mobile telephone number, an email address, a business registration number, a specified account or a combination thereof.

15. The electronic revenue and expenditure voucher management system as recited in claim 11, wherein said identification code is provided by a method selected from the group consisting of dictation, key-in, card access, RFID access, and a combination thereof.

16. The electronic revenue and expenditure voucher management system as recited in claim 11, wherein said user device is selectively one of a mobile phone, a computer, a personal digital assistant, a laptop computer, a tablet personal computer, a multi-media player or a combination thereof.

17. The electronic revenue and expenditure voucher management system as recited in claim 11, wherein an account is created on said shop platform if an identification code is accessed for the first time by said identification code input module, and the revenue and expenditure voucher information is imported into said central account corresponding to said identification code when said central unit is connected or the revenue and expenditure voucher information is imported after said central account corresponding to said identification code is created.

18. A method for managing an electronic revenue and expenditure voucher system, comprising steps of:
providing a central unit and a plurality of shop units, wherein said central unit comprises a central database and a management platform and each of said shop units comprises an revenue and expenditure voucher generator, a shop platform and a shop database;
providing an identification code of a member in one of said shop units;
creating an account corresponding to said identification code and sending a password to a user device of the member corresponding to said identification code when said shop platform determines that said identification code is accessed for the first time;
generating an electronic revenue and expenditure voucher with a revenue and expenditure voucher code according to the expenditure of the member;
storing said electronic revenue and expenditure voucher into said shop database corresponding to said account;
sending said revenue and expenditure voucher code to said user device of the member;
connecting said shop units with said central unit;
creating a central account corresponding to said identification code and sending another password to said user device when said management platform determines that said identification code is accessed for the first time; and
importing said electronic revenue and expenditure voucher into said central database corresponding to said central account.

19. The method as recited in claim 18, further comprising steps of:
generating consuming details corresponding to said electronic revenue and expenditure voucher; and
sending said consuming details to said user device corresponding thereto.

20. The method as recited in claim 18, further comprising a step of:
logging on to said shop platform or said management platform according to said identification code and said password to perform selectively one function of inspection, expenditure statistics, expenditure inquiry, lottery check, revenue and expenditure voucher donation or a combination thereof.

21. The method as recited in claim 18, wherein said identification code is selectively one of an identification number, a passport number, a telephone number, a mobile telephone number, an email address, a business registration number, a specified account or a combination thereof.
